(19) United States
(12) Patent Application Publication
(10) Pub. No.: US 2013/0114440 A1
(43) Pub. Date: May 9, 2013

(54) METHOD OF ACCELERATING NETFLOW DATA FILTERING

(71) Applicant: Wang Ming-Hui, Kaohsiung City (TW)

(72) Inventor: Wang Ming-Hui, Kaohsiung City (TW)

(21) Appl. No.: 13/585,151

(22) Filed: Aug. 14, 2012

(30) Foreign Application Priority Data
Nov. 3, 2011 (TW) 100220751

(51) Int. Cl. H04L 12/26

(52) U.S. Cl. 370/252

(57) ABSTRACT

The invention discloses a method of accelerating netflow data filtering by combining a central processing unit (CPU) with a graphics processing unit (GPU) to reduce energy consumption and the carbon emission. The method comprises the steps of reading a plurality of filter conditions and a part of netflow data in a program of a CPU; transferring the plurality of filter conditions and the part of netflow data from the CPU to a GPU in the display card; applying the plurality of filter conditions to the part of netflow data in a multi-thread kernel program of the GPU to obtain a plurality of filter results; transferring the plurality of filter results from the GPU to the CPU; merging the plurality of filter results to be a total filter result; and repeating the steps until the all data in the large amount of netflow data are filtered.

### BACKGROUND OF THE INVENTION

1. Field of the Invention

The present invention relates to a method of accelerating netflow data filtering, and in particular to a method of accelerating netflow data filtering by combining a central processing unit (CPU) with a graphics processing unit (GPU) to improve the efficiency of netflow data filtering.

2. Background

Netflow developed by Cisco is a network traffic statistical technique which is used to send out network traffic monitored by a network device in the flow unit. Flow is defined as a unidirectional data flow. In the same flow packets, the contents, which include five fields: Protocol, Source IP, Destination IP, Source Port and Destination Port, are the same. The flow data contains the transmitted statistical data, such as the number of packets and bytes. The transmitted data can be stored by collector software and then processed.

On the other hand, netflow data also can provide some extra applications, such as botnet detection. However, it is difficult to apply botnet detection with netflow data; because netflow data only contain the network traffic statistical data. The network transmitting workload of botnet in non-active period is very small. Therefore, other methods are used to detect the communication mode between the botnet C&C server [2] and bot computer. After obtaining these data, IPs that meet these conditions are found from netflow data for further process. With the growing network bandwidth, the netflow data is increased rapidly.

Among the huge netflow data of the flow statement, maybe only a small portion is needed to be filtered out. The filtering is conducted by simply search all records that meet the conditions of set D from netflow data N, and then placing into set R, namely:

R={Nᵢ|NᵢεD},D={Dⱼ|j=1 . . . n}

Ni is the i-th record in netflow data, which includes five fields: source IP, destination IP, source port, destination port, and protocol. Dj is the j-th condition, a combination of source IP, destination IP, source port, destination port and protocol. The below are some examples:

D1={Dst IP=128.1.1., Dst Port=6667}

D2={Dst IP=122.117.1.1, Src Port=80}

D3={Dst IP=192.168.1.1, Dst Port=53,

Protocol=UDP}

Referring to FIG. 1, it shows a flow process of netflow data filtering using the CPU of the prior art. The filter has many functions, such as finding all IPs once logged into gambling websites or connected with botnet C&C server. In these applications, the quantity of set D is large, and the conditions are not fixed, which may be composed of destination IP, source port, destination port, and communication protocols, and they are required to be compared one by one. Since netflow database is not frequently accessed like Google, it is not economical to establish the index for netflow data. In fact, it may take a longer time to establish index than sequential inquiry, and additional storage space is required. Thus, netflow data are stored by sequencing without special process or index, so every record is filtered by sequential comparison.

For example, D is set as 2048, and N employs actual data up to 3.3 billion. Every record must be compared 2048 times, and then it can be determined if it complied with either conditions in set D. Hence, at least 6.6×10¹² comparisons are required, and also depending on the available conditions.

Referring to FIG. 2, it shows an architecture of netflow data filtering using the CPU, wherein netflow data are divided into 8 parts, and processed separately by 8 threads in the same way. After eight results are generated, they will be merged and outputted. C language is adopted to compile the program codes. Finally, and then they will be merged and outputted. When it is tested on a four-core computer of Intel Core i7 920 2.66 GHz, the result of all data comparison takes about 119 minutes. It is too long for an hourly query. The daily stored netflow data have increased from MBs to GBs, or even over 100 GB for big-sized ISP. Thus, it takes a longer time to search the data meeting conditions. Under such circumstances, it is very difficult to process a huge quantity data with conventional central processing unit (CPU) architecture.

According above problems, it need a method to overcome the disadvantage of the prior art. Therefore, an application of the graphics processing unit (GPU) architecture to huge quantity data processing is disclosed in this invention.

### BRIEF SUMMARY OF THE INVENTION

It is an objective of the present invention to provide a method of accelerating netflow data filtering by combining a central processing unit (CPU) with a graphics processing unit (GPU) to improve the efficiency of netflow data filtering as well as to reduce energy consumption and the carbon emission.

To achieve the above objective, the present invention provides a method of accelerating netflow data filtering, used to filter a large amount of netflow data, comprising the steps of: step 1: reading a plurality of filter conditions and a part of netflow data in a program of a CPU; step 2: transferring the plurality of filter conditions and the part of netflow data from the CPU to a GPU in the display card; step 3: applying the plurality of filter conditions to the part of netflow data in a multi-thread kernel program of the GPU to obtain a plurality of filter results; step 4: transferring the plurality of filter results from the GPU to the CPU; step 5: merging the plurality of filter results to be a total filter result; and step 6: repeating the step 1 to the step 5 until the all data in the large amount of netflow data are filtered.

According to one aspect of the present invention, in step 3, the plurality of filter conditions and the part of netflow data are stored in a shared memory of the GPU.

According to one aspect of the present invention, wherein in step 3, the multi-thread kernel program of the GPU is a CUDA (Compute Unified Device Architecture) program in non-traditional 3D graphic presentation of the GPU.

According to one aspect of the present invention, wherein in step 3, a language used for the multi-thread kernel program of the GPU is C language.

According to one aspect of the present invention, in step 3, a thread number for the multi-thread kernel program of the GPU is fixed into 512 in every multiprocessor of the GPU.

According to one aspect of the present invention, as the plurality of filter conditions and the part of netflow data are stored in the shared memory of the GPU, the GPU still continue to read the shared memory for enhancing the performance without withstanding the inconsistent shared memory that processed by each thread.

According to one aspect of the present invention, the netflow data are divided into five groups to store source IP, destination IP, source port, destination port, and transmission capacity separately.

According to one aspect of the present invention, the netflow data that processed by the same thread are not stored in a continuous memory.

According to one aspect of the present invention, the netflow data that processed by the same thread are stored in a continuous memory when several threads are executed in sequence.

According to one aspect of the present invention, the program of a CPU reads more than 64 filter conditions.

The disclosed invention discloses an optimal CUDA program based on some GPU characteristics, which are placing common variables on the share memory, increasing the thread numbers, rearranging the netflow data access sequence, and changing the data access mode. And the program performance is improved markedly, almost 11 times of pure CPU program under 2048 filter conditions. The improved performance and operating time reduction is meaningful in declining the energy consumption.

These and many other advantages and features of the present invention will be readily apparent to those skilled in the art from the following drawings and detailed descriptions.

### BRIEF DESCRIPTION OF THE DRAWINGS

All the objects, advantages, and novel features of the invention will become more apparent from the following detailed descriptions when taken in conjunction with the accompanying drawings.

Table 1. Execution wall clock times, in seconds, of the GPU and CPU (Core i7 920) calculation for different condition sizes. The average time is 3 runs.

FIG. 1 shows a flow process of netflow data filtering using the CPU of the prior art.

FIG. 2 shows an architecture of netflow data filtering using the CPU, wherein netflow data are divided into 8 parts, and processed separately by 8 threads. Afterwards, it will be merged and outputted.

FIG. 3 shows an architecture of netflow data filtering using the CPU combined with the GPU, wherein each GPU thread response for one filter condition, only 2048 threads are required for all conditions.

FIG. 4 shows scheduling process of threads for the netflow data filtering using the CPU combined with the GPU, each of which only executes memory access. (a) Only 2 threads, memory's latency is 4 clocks. (b) 5 threads, memory's latency is also 4 clocks.

FIG. 5 shows the memory access for the netflow data filtering using the CPU combined with the GPU, wherein the same color blocks represent the data that will be processed by the same threads.

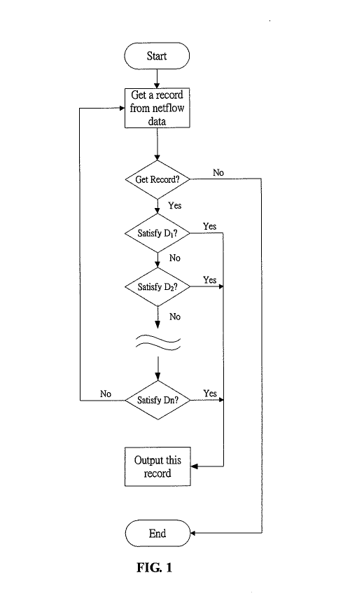

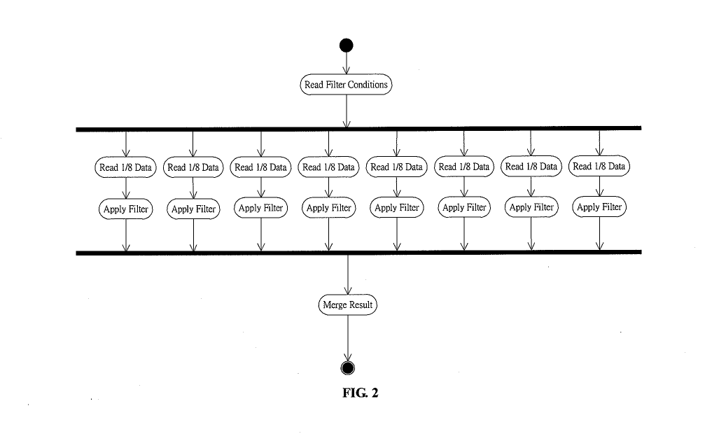

### DETAILED DESCRIPTION OF THE INVENTION

The functions and the advantages of the present invention have been shown. Although the invention has been explained in relation to its preferred embodiment, it is not used to limit the invention. It is to be understood that many other possible modifications and variations can be made by those skilled in the art without departing from the spirit and scope of the invention as hereinafter claimed.

The architecture and computing power of GPU has kept the pace with or even exceeded the development and performance of CPU. Some graphic chip manufacturers are now trying to enhance the 3D image. They provide the large number with higher complexity of transistors in GPU. Compare to the CPU, the floating-point calculating capacity of GPU is several times of CPU. At present, GPU is composed of numerous execution units, each of which is applied to the operation of Vertex, Geometry, or Pixel, and also can be configured flexibly depending on the operating conditions. Similar to existing multi-core processors, such architecture adopts the concept of multi-thread parallel computation, helping to accelerate the computation per unit time and give full play to each unit.

The GPU can provide the excellent parallel computation and floating-point operation, so it has been widely applied by worldwide research institutions to develop applications or conduct researches in diverse fields, such as life science, medical facilities, productivity, energy exploitation, finance, economy, manufacturing, and telecommunication. This invention applied GPU to filter the large amount of netflow data, and the embodiment shows that GPU's processing speed was around 11 times faster than multi-core CPU.

Since the GPU design is more complex than the processor, and GPU's parallel processing of floating-point calculation has surpassed the current processor by several times, GPU is utilized in lieu of CPU. This GPU application in non-traditional 3D graphic presentation is generally called GPGPU (General-purpose computing on graphics processing units). In 2007, nVidia published the development technology named CUDA (Compute Unified Device Architecture) for GPGPU application, which allow the programmers combine C language with CUDA's designated extension syntax to develop the programs. Obviously it is compiled by NVCC compiler, and then processed by GPU.

There are two CUDA application programming interfaces (APIs) available for the developers, which are Runtime and Driver API. Runtime API is a high-level API that can be easily learned by the developers, and the performance relatively inferior to Driver API. In contrast with Runtime API, Driver API increases the program complexity, but the performance is not improved tremendously, so Runtime API has been extensively used. CUDA application is also executed on CPU, but GPU mainly focused on numerous data for parallel computation. For instance, in a 10,000×10,000 matrix multiplication, CPU is responsible for allocating memory and reading matrix data, the calculation is computed by GPU kernel program, and the result is outputted by CPU. Thus, two programs have to be designed for CUDA; one program for execution on CPU, and the other one (kernel) for execution on GPU, both are collaboratively processed to finish the computation. As a high parallel computing procedure, it is quite suitable to accelerate the computing by GPU, which could achieve a computing speed that is 69 times faster than the computer of 8CPU cores.

Since the programs developed by nVidia CUDA could provide excellent performance of parallel and floating-point computing from GPU, worldwide research institutes have already employed CUDA to compile programs or conduct researches, including life science, medical facilities, productivity, energy exploitation, finance, economy, manufacturing, and telecommunication. This invention applies the CUDA to filter a large amount of netflow data, and the experiments proved that GPU can perform a high speed processing, which is 11 times faster than multi-core CPU.

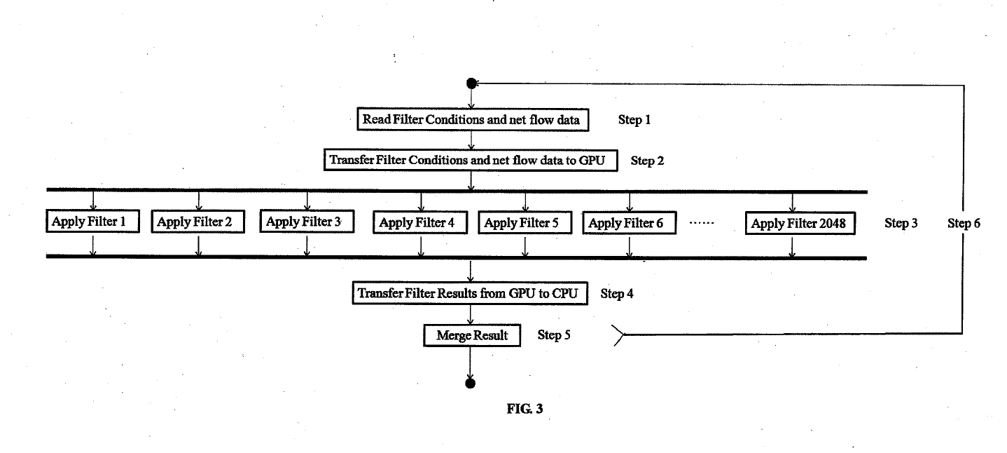

To understand the spirit of the present invention, now please referring to FIG. 3, it shows an architecture of netflow data filtering using the CPU combined with the GPU, wherein each GPU thread response for one filter condition, only 2048 threads are required for all conditions. The method of accelerating netflow data filtering according to the present invention comprises the steps of:

step 1: reading a plurality of filter conditions and a part of netflow data in a program of a CPU;

step 2: transferring the plurality of filter conditions and the part of netflow data from the CPU to a GPU in the display card;

step 3: applying the plurality of filter conditions to the part of netflow data in a multi-thread kernel program of the GPU to obtain a plurality of filter results;

step 4: transferring the plurality of filter results from the GPU to the CPU;

step 5: merging the plurality of filter results to be a total filter result; and

step 6: repeating the step 1 to the step 5 until the all data in the large amount of netflow data are filtered.

In an embodiment, the invention adopted a multi-thread CUDA program, and each thread has been compared with a condition of all data, so 2048 threads are required for all conditions. Due to the display card memory limitation, only a part of data can be processed in each time. In the beginning a part of data was read by the CPU program, and then the data and filter conditions were transferred to the display card memory. Filtering then was performed by GPU's kernel program, and the results were sent back to CPU for merging. This procedure will be repeated until all data were filtered. The filtering speed performance has been improved to that all data comparison can be finished within 12 minutes under the actual test. That is, the improvement is from 119 minutes to 36 minutes.

In this present invention, the plurality of filter conditions and the part of netflow data are stored in a shared memory of the GPU, and the multi-thread kernel program of the GPU is a CUDA (Compute Unified Device Architecture) program in non-traditional 3D graphic presentation of the GPU. Moreover, a language for the multi-thread kernel program of the GPU use is C language. And, in step 3, a thread number for the multi-thread kernel program of the GPU is fixed into N in every multiprocessor of the GPU, wherein N is 2^{P}, P is a positive integer. For example, N can be 16, 32, 64, 128, 256 or 1024 and so on. In this embodiment, N is 512, however, N is not limited to 512 in the practical case.

In order to further accelerating netflow filtering, the CPU's architecture and characteristics must be understood and considered thoroughly. The common GPU architecture is composed of many multiprocessors, e.g. 27 multiprocessors for the experimental nVidia 260GTS. There are several Scalar Processors with an independent cache in each multiprocessor. While the Shared Memory along with Constant and Texture Cache, it can also be shared by a Scalar Processor in the same Multiprocessor. With its own cache, the access speed of Scalar Processor is the fastest, followed by Shared Memory, and then the Constant and Texture Cache. The Device Memory which is the memory on the display card is the latest. Thus, in order to accelerate the program speed in this filter, the most commonly-used data, the conditional data, has been stored in Shared Memory with limited capacity.

The next step is to filter the netflow data. Because of the large data amount, the data have to be stored in the Device Memory. However, the latency of memory access may occur. To prevent the influence of memory's latency on the performance, the CPU has to apply the cache for reducing the frequency of main memory access. Normally the GPU does not embed with cache, but it hides memory's latency by parallel execution. So while the first thread is waiting for the memory access, the second thread will be executed, and so forth. Thus, to optimize CUDA, the numerous parallelisms are required to hide the memory's latency efficiently, and utilize many execution units on GPU effectively.

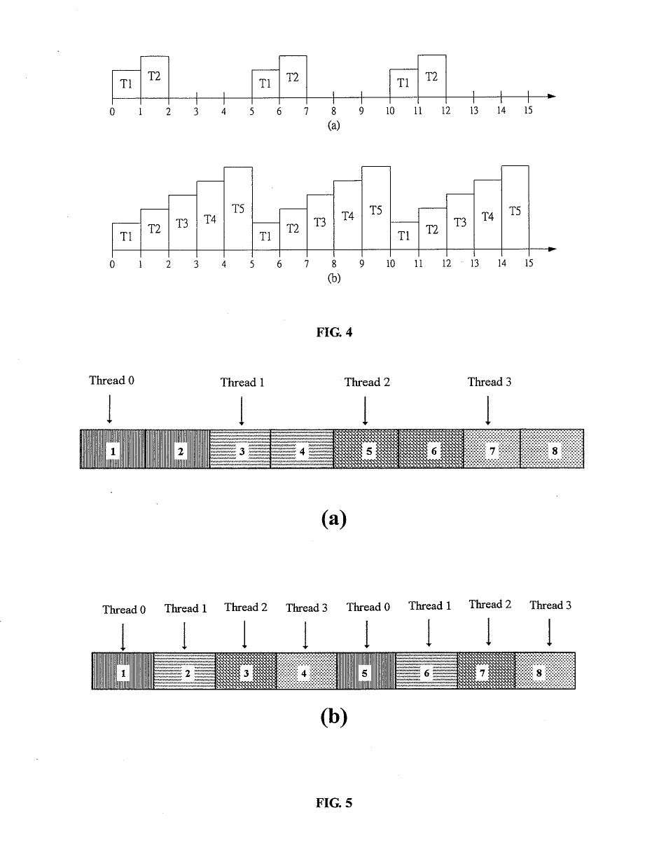

Now referring to FIG. 4, it shows scheduling process of threads for the netflow data filtering using the CPU combined with the GPU, each of which only executes memory access. (a) Only 2 threads, memory's latency is 4 clocks. (b) 5 threads, memory's latency is also 4 clocks. It is assumed that memory's latency is around4clocks; only two threads in FIG. 4(a) are running. While T1 is reading memory at clock 0, T2 will execute at clock 1. Nevertheless, the latency will caused T1 can't execute until the clock 5, so each cycle will take 3clocks for memory access. In FIG. 4(b), the thread number increases to 5. Once 5 threads are executed in a cycle, the memory data accessed by T1 are just prepared, so the memory latency won't be found, accounting for the principle of hidden memory's latency by numerous threads.

There are about 500 clocks of the memory latency on the display card, so at least 500 threads are needed to hide the memory's latency sufficiently. Hence, the program has to modify extensively. First of all, the conditions of dependent thread number are modified and fixed into 512 in every multiprocessor, and each thread is in charge of processing 1/512 data. There are 27 multiprocessors on the nVidia display card, so the amount of threads executed simultaneously is 13824. Therefore, it is preferably that a thread number for the multi-thread kernel program of the GPU is fixed into 512 in every multiprocessor of the GPU.

The method of memory access by GPU is also considered in this invention. Since GPU provides the best efficiency in continuous memory access, the access sequence will be arranged specifically to optimize the GPU performance. In a multi-thread program, a block of continuous data memory is assigned for all of the threads, each thread is responsible for processing the memory contents in that block as shown in FIG. 5(a). However, such assignment will decrease GPU efficiency, because the program will reach to Thread1 immediately when Thread 0 reads the memory. In this situation, the memory address accessed by Thread 1 is not consistent with Thread 0, and that might cause the worse efficiency. In this invention, as shown in FIG. 5(b), not withstanding the inconsistent memory that processed by each thread, the GPU still continue to read the memory for enhancing the performance. It is preferably that the plurality of filter conditions and the part of netflow data are stored in the shared memory of the GPU, the GPU still continue to read the shared memory for enhancing the performance without withstanding the inconsistent shared memory that processed by each thread.

On the other hand, the storage of Netflow data has to be changed properly. Since each data structure is used to store source IP, destination IP, source port, destination port, and transmitting capacity separately, this storage is not suitable for continuous memory access. So the data are divided into five groups to store source IP, destination IP, source port, destination port, and transmission capacity separately. Afterwards, each thread reads the data groups by hopping 512 records.

Now referring to the FIG. 5, it shows the memory access for the netflow data filtering using the CPU combined with the GPU, wherein the same color blocks represent the data that will be processed by the same threads. The original data arrangement in the memory is shown in FIG. 5(a), the data that will be processed by the same threads are arranged in the continuous blocks, but the memory will access discontinuously if several threads are executed in sequence. Hence, the actual memory access sequence of four threads in FIG. 5(a) is: 1→3→5→7→2→4→6→8. After the modification, the data sequence in the memory will be dispersed, as shown in FIG. 5(b). Although the data that processed by the same thread are not stored in a continuous memory block, the continuous memory access is possible when several threads are executed in sequence. After modification, the memory access sequence is 1→2→3→4→5→6→7→8. Namely, the netflow data that processed by the same thread are not stored in a continuous memory. However, the netflow data that processed by the same thread are stored in a continuous memory when several threads are executed in sequence.

In this way, GPU can access the continuous memory blocks to accelerate the process. As the test result showed, the data processing can be completed within 10 minutes and 46 seconds. When the program is operated, the CPU will take a moment to access the data from hard disk (HD) to memory, so the better the HD access improved, the faster the program operation will be.

After optimizing the CUDA program, following shows an embodiment according to the present invention. It was designed to compare the operating speed between GPU and CPU. In the comparison procedure, GPU1 represented the non-optimized program, and GPU2 represented the optimized program. GPU operation was accomplished by Core i7 920 along with a nVidia GTX 260+ graphic card. CPU operation was only accomplished by a single Core i7 920 with Hyper Thread CPU. All programs were computed with 8 threads. By changing the amount of filter conditions, the time of filtering all data was measured separately, and the final results were listed in Table 1.

Table 1 shows execution wall clock times, in seconds, of the GPU and CPU (Core i7 920) calculation for different condition sizes. The average time is 3 runs. As shown in Table 1, when the filter conditions are below 64, GPU operation is not faster than CPU operation. Because of the GPU data arrangement and transfer between main memory and graphic card usually need some time to process. Preferably, the program of a CPU reads more than 64 filter conditions. When there are over 64 filter conditions, the GPU operation time has changed a little, but the CPU operation time becomes longer. This makes the different operating speed between GPU and CPU. Although GPU1 is not optimized yet, the operation time is still maintained at about 2100 seconds, and finally it is 3 times faster than CPU. The optimized GPU2 operating speed is much faster, since the operation time only lasts for 600 seconds, it is 3 times faster than GPU1 and almost 11 times than CPU.

In addition, when there are 32 and 64 conditions for GPU2, the computing time for 64 filter conditions is quite short. Other than the experimental data error, there are 27 multiprocessors for our graphic card. According to the design, all conditions are assigned evenly to each multiprocessor, but the number of conditions cannot be divided exactly by 27, leading to uneven assignment, especially when there are little conditions. For example, when there are 32 filter conditions, 22 multiprocessors are provided with small filter conditions at a rate of 1:2. When there are 64 filter conditions, only 17multiprocessors are provided with small filter conditions, showing shorter computing time than 32 filter conditions. Namely, it is preferably that the program of a CPU reads more than 64 filter conditions.

According to the embodiment, the CPU operation combined with GPU can improve the netflow data filtering substantially, or even up to 11 times faster. Besides, the GPU operation without optimizing is also close to 3 times of CPU. In contrast, the operating time of GPU1 and GPU2 are insignificantly, which only less than 70 s of maximum and minimum value. The CPU operating time changes obviously with increased conditions, or even by geometric series. In relation to CPU, GPU is a very stable algorithm.

In addition to the performance improvement, such combination will also contribute to energy conservation. If calculated by pure CPU operation, the energy consumption of entire system is about 178W; after running 7124 seconds, it will be brought into the carbon emission formula: C=0.637·P·H/1000 (Kg), where C is Carbon emission, P is Consumed power and H is Number of hours.

The carbon emission is 224.38 g if combined with GPU operation. The energy consumption of entire system is about 368Wafter adding 190W graphic card consumption. Since it only runs for 647 seconds, the carbon emission is calculated as 42.13 g, which is 182.25 g less than pure CPU. If operated 1 time every 1 hour and 24 times per day, nearly 1596.51 Kg carbon emission can be reduced in a year.

This invention is disclosed to improve the efficiency of netflow filtering by utilizing GPU. Initially, a pure CPU program has been designed, and then a simple CUDA program to execute the netflow filtering. Before optimizing was made according to GPU characteristics, the efficiency merely improved triple. Then, an optimal CUDA program was designed based on some GPU characteristics, which are placing common variables on the share memory, increasing the thread numbers, rearranging the netflow data access sequence, and changing the data access mode. And the program performance was improved markedly, almost 11 times of pure CPU program under 2048 filter conditions. The improved performance and operating time reduction is meaningful in declining the energy consumption.

The functions and the advantages of the present invention have been shown. Although the invention has been explained in relation to its preferred embodiment, it is not used to limit the invention. It is to be understood that many other possible modifications and variations can be made by those skilled in the art without departing from the spirit and scope of the invention as hereinafter claimed.

TABLE 1

| No. of conditions | CPU | GPU1 | GPU2 | Speedup |
|---|---|---|---|---|
| 16 | 481.15 | 2073.63 | 577.9 | 0.83 |
| 32 | 519.82 | 2076.52 | 578.88 | 0.90 |
| 64 | 594.99 | 2083.18 | 575.31 | 1.03 |
| 128 | 756.31 | 2099.4 | 577.29 | 1.31 |
| 256 | 1115.68 | 2106.56 | 588.2 | 1.90 |
| 512 | 1992.64 | 2111.9 | 588.41 | 3.39 |
| 1024 | 3603.93 | 2113.38 | 604.67 | 5.96 |
| 2048 | 7124.05 | 2155.44 | 646.86 | 11.01 |

What is claimed is:

1. A method of accelerating netflow data filtering, used to filter a large amount of netflow data, comprising the steps of:
step 1: reading a plurality of filter conditions and a part of netflow data in a program of a CPU;
step 2: transferring the plurality of filter conditions and the part of netflow data from the CPU to a GPU in the display card;
step 3: applying the plurality of filter conditions to the part of netflow data in a multi-thread kernel program of the GPU to obtain a plurality of filter results;
step 4: transferring the plurality of filter results from the GPU to the CPU;
step 5: merging the plurality of filter results to be a total filter result; and
step 6: repeating the step 1 to the step 5 until the all data in the large amount of netflow data are filtered.

2. A method of accelerating netflow data filtering as claimed in claim 1, wherein in step 3, the plurality of filter conditions and the part of netflow data are stored in a shared memory of the GPU.

3. A method of accelerating netflow data filtering as claimed in claim 1, wherein in step 3, the multi-thread kernel program of the GPU is a CUDA (Compute Unified Device Architecture) program in non-traditional 3D graphic presentation of the GPU.

4. A method of accelerating netflow data filtering as claimed in claim 3, wherein in step 3, a language used for the multi-thread kernel program of the GPU is C language.

5. A method of accelerating netflow data filtering as claimed in claim 1, wherein in step 3, a thread number for the multi-thread kernel program of the GPU is fixed into 512 in every multiprocessor of the GPU.

6. A method of accelerating netflow data filtering as claimed in claim 2, wherein as the plurality of filter conditions and the part of netflow data are stored in the shared memory of the GPU.

7. A method of accelerating netflow data filtering as claimed in claim 1, wherein the netflow data are divided into five groups to store source IP, destination IP, source port, destination port, and transmission capacity separately.

8. A method of accelerating netflow data filtering as claimed in claim 1, wherein the netflow data that processed by the same thread are not stored in a continuous memory.

9. A method of accelerating netflow data filtering as claimed in claim 8, wherein the netflow data that processed by the same thread are stored in a continuous memory when several threads are executed in sequence.

10. A method of accelerating netflow data filtering as claimed in claim 1, wherein in the step 1, the program of a CPU reads more than 64 filter conditions.
